(19) United States
(12) Patent Application Publication
(10) Pub. No.: US 2019/0034978 A1
(43) Pub. Date: Jan. 31, 2019

(54) COMPUTER-IMPLEMENTED METHOD AND SYSTEM FOR BIDDING

(71) Applicant: INMOBI PTE LTD, Singapore (SG)

(72) Inventors: Vijay KARTHIK, Delhi (IN); Anita VASU, Bangalore (IN); Gunjan SHARMA, Khandwa (IN)

(73) Assignee: INMOBI PTE LTD, Singapore (SG)

(21) Appl. No.: 16/046,418

(22) Filed: Jul. 26, 2018

(30) Foreign Application Priority Data
Jul. 26, 2017 (IN) 201741026593

(51) Int. Cl. G06Q 30/02

(52) U.S. Cl. CPC G06Q 30/0275; G06Q 30/0277

(57) ABSTRACT

A computer-implemented method and system of successive bidding enables placement of an electronic advertisement on one or more electronically distributed content. The method includes receiving, at a bidding server, a target cost per click (tCPC) and information indicative of a “total amount of resource”, receiving, by the bidding server from a first server, a request for a first bid for placing the electronic advertisement on a first electronically distributed content, transmitting, by the bidding server to the first server, a first bid value (bid₁) calculated by the bidding server. The method further includes receiving, by the bidding server from the first server and/or a further server, a request for nth bid for placing the electronic advertisement on the first electronically distributed content and/or a further electronically distributed content; and transmitting a nth bid value (bidₙ) calculated by the bidding server.

### FIELD OF THE INVENTION

The present disclosure relates to advertising and, in particular, optimizing bid prices for online advertising auctions.

### BACKGROUND

A publisher can publish content via a site, app or blog. These content include dedicated area on their site reserved to display ads or creative. The act of displaying or serving a creative on a site, such as a mobile site or an app is often referred to as an impression. The placement of ads on the publisher's mobile site or app incur costs because of multiple advertisers aiming for placement of their respective ads on the same position on a particular mobile site or app. Also, publishers aim for an increased revenue from high quality ads being displayed on their mobile site or app.

Often ad networks act as intermediaries between multiple publishers and multiple advertisers. The role of ad networks is to aggregate and connect the advertisers who want to buy advertising space with publishers who offer inventory. The ad networks conduct auctions in which selling and buying of ad spaces take place based on different pricing or payment models such as cost per click (CPC), cost per thousand impressions (CPM) and cost per acquisition (CPA). In the CPM model, advertisers typically pay for every impression of their advertisement, the price paid for each impression is measured in price per 1000 (“mille”) impressions. In the CPC model, advertisers typically pay each time a viewer clicks on their advertisement. In the CPA model, advertisers pay for every action, such as a sale or registration, completed as a result of a viewer clicking on their advertisement. Accordingly advertisers bid for the ad spaces on either a CPC basis, or CPM basis or CPA basis, where the bid values are established through the auction outcomes.

While conducting auctions, the ad networks are assigned by the advertisers, a budget or a fixed amount, which they are willing to spend on an ad campaign, for example, 50 USD for generating 100 clicks, or 10,000 USD in total for an entire ad campaign. In some cases, a target cost per click and a total resource amount to be spent on bidding for an advertisement or an ad-campaign is provided by the advertisers to the ad-networks. The ad networks acting as intermediary between the advertisers and publishers rely on bidding systems to achieve the target cost per click set by the advertisers. At the same time, depending upon the performance of the bidding system conducting the auctions, the ad-networks may either gain when they are able to achieve the target cost per click or bear a loss if the amount spent by the ad-networks from the total amount of resource, per click, also known as effective cost per click (eCPC) is more than the target cost per click.

With the advent of programming advertising, real time bidding is now implemented more in practice by ad networks for buying and selling ad spaces. Real time bidding is an automated way of media buying, where advertising space is bought and sold on a per-impression basis determined in real time. Real time bidding systems rely on the ability of learning models to accurately and reliably predict click-through rates of advertisements. In practice, predicting click-through rates may be relatively easy for advertisements that have been previously displayed in online auctions, especially for those advertisements that have been displayed many times and consequently have substantial click history which may be collected. However, where there may be minimal click history for advertisements, or for a brand new advertisement, predicting click-through rates may be difficult to estimate. It is a challenge to accurately predict click-through rates to determine the most relevant ads and to price them correctly in an online auction.

Predicting click-through rates using machine learning from past performances has also been considered by bidding systems. However, in the case of unknown websites or new ads, relying on predicted click-through rates cannot guarantee return on investment for advertisers or revenue for publishers respectively.

In view of the above, there is a need for a real time bidding system that accurately predicts click-through rates for advertisements. Additionally, such real-time bidding system should be able to optimize all the factors affecting the real-time bidding, to the effect of, delivering maximum return on investment for advertisers and delivering increased revenues for the publishers.

### SUMMARY

This summary is provided to introduce a selection of concepts in a simplified format that are further described in the detailed description of the invention. This summary is neither intended to identify key or essential inventive concepts of the invention, nor is it intended for determining the scope of the invention.

The present invention provides computer-implemented method and system for real-time bidding that implements the disclosed learning model and statistics to achieve desired output in terms of bid values. More particularly, the desired output is that at least an effective cost per click, spent by ad networks on ad campaigns, should be less than or equal to the target cost per click, set by the advertisers. At the same time, the desired output bid values should be winning the bids/auctions being conducted. Further, keeping in view the problems thus faced by real-time bidding systems, the present invention contemplates a learning model for the real-time bidding system that assist the real-time bidding system in determining the desired output bid values. Further, the real-time bidding system determines click-through rates that can be applied for determining bid values even in case of new creative or new sites without eliminating any of the factors (creative, sites etc.) involved in predicting the click-through rates.

In accordance with an embodiment of the present invention, a computer-implemented method of successive bidding in relation to placement of an electronic advertisement on one or more electronically distributed content is disclosed. The method comprises of receiving, at a bidding server, a target cost per click (tCPC) and an information indicative of a “total amount of resource”. Further, the method comprises of receiving, by the bidding server from a first server, a request for a first bid for placing of the electronic advertisement on a first electronically distributed content, and transmitting, by the bidding server to the first server, a first bid value (bidₙ) calculated by the bidding server, as bid₁=adjustment factor*tCPC*pCTR₁, where adjustment factor₁is equal to 1, and pCTR₁ is a predicted click through rate corresponding to the first bid. Further, the method comprises of receiving, by the bidding server from the first server and/or a further server, a request for nth bid for placing of the electronic advertisement on the first electronically distributed content and/or a further electronically distributed content; and transmitting, by the bidding server to the first server and/or the further server, a nth bid value (bidₙ) calculated by the bidding server as bidₙ=adjustment factorₙ*tCPC*pCTRₙ, where pCTRₙ is predicted click through rate corresponding to the nth bid, and adjustment factorₙ being determined by the bidding server, as: adjustment factorₙ=adjustment factor₍ₙ₋₁₎*(1−α((eCPC-tCPC)/eCPC)), where eCPC is an effective cost per click, n is greater than or equal to 2, and α is a non-zero fraction having a value between 0 and 1.

In accordance with a further embodiment of the present invention, the predicted click-through rate corresponding to the first bid is calculated as: pCTR=β_{a,i}*β_{s,j}*β_{c,k.} β_{a,i} represents an advertiser related feature affecting the predicted click through rate; β_{s,j} represents an electronically distributed content related feature affecting the predicted click through rate; and β_{c,k} represents an electronic advertisement related feature affecting the predicted click. β_{a,i} is calculated by the bidding server, as: β_{a,i}=(Σ_{j,k} wᵢⱼₖ*pᵢⱼₖ*β_{s,j}*β_{c,k})/(Σ_{j,k} wᵢⱼₖ*β_{s,j}²*β_{c,k}²). β_{s,j} is calculated by the bidding server, as: β_{s,j}=(Σ_{i,k} wᵢⱼₖ*pᵢⱼₖ*β_{a,i}*β_{c,k})/(Σ_{i,k} *wᵢⱼₖ*β_{a,i}²*β_{c,k}²). β_{c,k} is calculated by the bidding server, as: β_{c,k}=(Σ_{i,j} wᵢⱼₖ*pᵢⱼₖ*β_{a,i}*β_{s,j})/(Σ_{i,j} wᵢⱼₖ*β_{a,i}²*β_{s,j}²). Herein wᵢⱼₖ represents a number of impressions for an advertiser=‘i’, an electronically distributed content=‘i’, and an electronic advertisement=‘k’, and pᵢⱼₖ is a previously determined value of the click through rate for a combination of the advertiser ‘i’, the electronically distributed content ‘j’, and the electronic advertisement ‘k’.

In accordance with another embodiment of the present invention, a bidding server for successive bidding, is disclosed, the bidding being in relation to a placement of an electronic advertisement on one or more electronically distributed content. The bidding server comprises of a first receiving unit to receive a target cost per click (tCPC) and an information indicative of a “total amount of resource”, a second receiving unit to receive from a first server, a request for a first bid for placing of the electronic advertisement on a first electronically distributed content, and to further receive from the first server and/or a further server, a request for nth bid for placing of the electronic advertisement on the first electronically distributed content and/or a further electronically distributed content. Further, the bidding server comprises of a processor to calculate a first bid value (bid₁) and to calculate a nth bid value bid value (bidₙ), wherein the first bid (bid₁) value is calculated as: bid₁=adjustment factor₁*tCPC*pCTR1, where adjustment factor₁ is equal to 1, and pCTR₁ is a predicted click through rate corresponding to the first bid. And wherein the nth bid (bidₙ) value is calculated as bidₙ=adjustment factorₙ*tCPC*pCTRₙ, where pCTRₙ is predicted click through rate corresponding to the nth bid, adjustment factorₙ being determined by the bidding server, as: adjustment factorₙ=adjustment factor₍ₙ₋₁₎*(1-60 ((eCPC-tCPC)/eCPC)), where eCPC is an effective cost per click, n is greater than or equal to 2, and α is a non-zero fraction having a value between 0 and 1. Further, the system comprises of a transmitter to transmit the first bid value to the first server and the nth bid value to the first server and/or the further server.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a method in accordance with an embodiment of the present invention.

FIG. 2 illustrates a system implementing a method in accordance with an embodiment of the present disclosure.

FIG. 3 illustrates a typical hardware configuration of a system implementing a method in accordance with the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

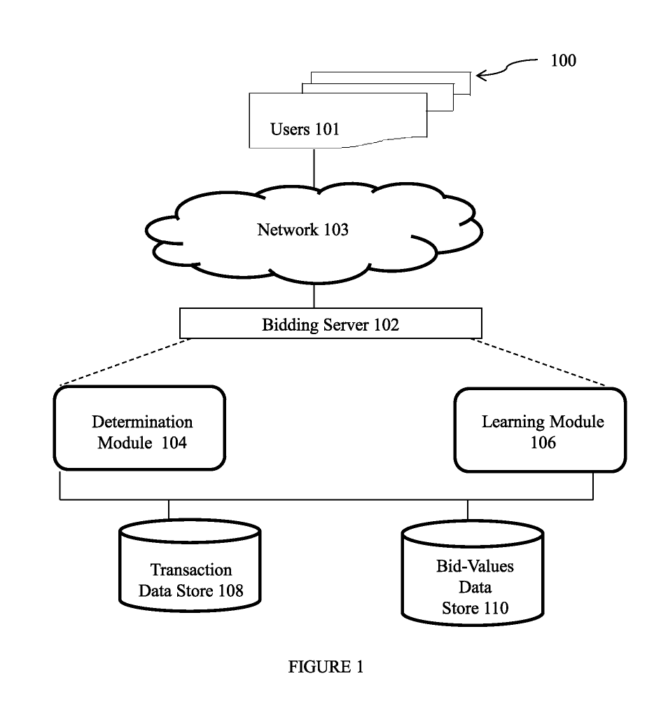

FIG. 1 illustrates a system 100, in accordance with an embodiment of the present invention, for determining bid values for successive bidding in an auction (or bid) in relation to placement of an electronic advertisement on one or more electronically distributed contents. The one or more electronic advertisements include mobile content advertisements, website content advertisements, or any other form of electronic media that appear as advertisements on electronically distributed contents. The term ‘electronic advertisement’, ‘advertisement’, ‘ads’ and ‘creative’ have been interchangeably used in this document and shall refer to the same meaning within the scope of the present invention. Further, the term ‘ad-campaign’ refers to one or more advertisements by the same advertiser that may be bid for in a predefined bidding period. The one or more electronically distributed contents include mobile sites, mobile applications (also referred to as ‘apps’), web sites, blogs etc. and other related media contents that can be distributed electronically using Internet. The electronic advertisements can be in different formats such as, standard contextual advertisements, video advertisements, banner advertisements, rich media content etc. However, the present invention is also applicable to any other form of electronically distributed content and can include any other format of advertisements.

As shown in FIG. 1, the system 100 includes a plurality of users 101, a bidding server 102, and a communication network 103. The plurality of users includes buyers and sellers in respect of the advertisements. A buyer can be an advertiser or an ad network who wishes to buy or pay for a space and/or a position, hereinafter referred to as ‘ad-space’, on one or more electronically distributed contents, to show their advertisements. A seller can be a publisher, or an ad network such as a news publisher, an e-commerce webpage etc., who provides ad-spaces on his electronically distributed content for publishing advertisements. The ad network refers to an intermediary entity between the advertisers and publishers.

The bidding server 102 comprises software components and data stores that can be employed at one or more data centers (not shown). The bidding server 102 determines successive bid values for securing an ad-space for placement of the electronic advertisement(s). The ad spaces are offered by the respective one or more sellers to the buyers by means of an auction. The terms ‘auction’, ‘bidding’ and ‘bidding process’ have been interchangeably used in this document and shall refer to the same meaning. Thus, the successive bids being generated are in relation to placement of the electronic advertisements on one or more electronically distributed contents. In one implementation, the bidding server is a part of an advertisement-serving platform (not shown). The advertisement-serving platform refers to a computing platform that enables advertisers to manage, deliver and display the electronic advertisements on the electronically distributed contents of the publishers. The bidding server 102 computes the bid values once the advertisement to be served is finalized. In a further implementation, the bidding server 102 computes the bid values in real-time.

Further, the bidding server 102 includes at least a determination module 104, a learning module 106, a transaction data store 108 and a bid-values data store 110. The determination module 104 determines successive bid values for placement of the electronic advertisement on the electronically distributed content(s). The successive bid values are determined each time a bidding request is received at the bidding server 102. The successive bid values may vary based on one or more conditions. The one or more conditions at least include an adjustment factor determined at the bidding server 102. In one implementation, the adjustment factor is determined by the bidding server 102 for each and every bidding request received at the bidding server 102 and accordingly the successive bid values may vary. In another implementation, the adjustment factor is determined by the bidding server 102 periodically and accordingly the successive bids may not vary for each and every bidding request received at the bidding server 102. For example, the adjustment factor can be determined after every 30 minutes, or 1 hour or every nth hour of the day. Accordingly, the successive bids may vary every 30 minutes, or every 1 hour or every nth hour of the day. However, such example should not be construed as limiting to the present invention. The adjustment factor shall be described in detail below.

Further, the one or more conditions on which the successive bid values depend upon are a predicted click-through rate for the corresponding advertisement and a target cost per click (tCPC). In the present implementation, the predicted click-through rate is determined by the bidding server 102 for each and every bidding request received at the bidding server 102 and accordingly the successive bid values may vary when the predicted click-through rate as determined for the corresponding bidding process varies. The target cost per click (tCPC) is set by the advertiser and can be set to be different for successive biddings in an ad-campaign. Accordingly, the successive bid values may vary when the tCPC for the corresponding bidding process varies.

The determination module 104 further determines a predicted click-through rate of an advertisement. The predicted click-through rate (pCTR) can be based on a plurality of independent factors β₁ to βₙ. Each of these independent factors can be related to one or more features such as an advertiser related feature, an electronic advertisement related feature, a site related feature etc., and the values of the factors can be one of the possible values of the features, such as β₁ᵢ, β₂ⱼ, etc. However, these one or more such factors may also be dependent upon each other without going beyond the scope of the present invention. The determination module 104 calculates the predicted click-through rate as, pCTR=β₁ᵢ*β₂ⱼ*β₃ₖ. . . *βₙₘ, (referred to as equation 1a).

The determination module 104 may further determine an effective cost per click (eCPC) in respect of the placement of the electronic advertisement on one or more electronically distributed contents. The effective cost per click is a total amount spent on publishing the advertisement/total number of clicks received by that advertisement. The effective cost per click for the advertisement may be determined at the end of every bidding process. In another implementation, the effective cost per click may be determined periodically. In a further implementation, the effective cost per click is determined for a bidding process which involves an adjustment factor determined in a previous bidding process, i.e., adjustment factor₍ₙ₋₁₎.

The learning module 106 provides a learning factor α to the determination module 104. The determination module 104 determines the adjustment factor based on the learning factor a for a successive bidding process. The selection of learning factor α is based on machine-learning (computer-implemented) from the output bid values of the bidding server 102. In one implementation, the learning factor α being provided to the determination module 104 is dependent upon at least one of the total amount of resource and an available amount of resource. Information indicative of the total amount of resource can be provided by the advertiser or the ad-network to the bidding server 102. The total amount of resource is a fixed budget to be spent on bidding for an advertisement or an ad-campaign. The available amount of resource corresponds to a balance amount remaining, with respect to the total amount of resource, after the first bidding or one previous bidding step. Herein, the determination module 104 determines the available amount of resource and provides the same to the learning module 106. By way of an example, the learning factor a can be a constant, or a number value, that is proportional to the amount spent in the previous bidding process. The previous bidding process herein corresponds to an adjusted bid value, i.e., determined with an adjustment factor. The amount spent in the previous bidding process can be with respect to the total amount of resource, or in some cases with respect to a daily amount of resource, a weekly amount of resource, or an hourly amount of resource, etc. which can be set by the advertiser or the ad-network depending upon the total amount of resource and the available amount of resource. By way of another example, the learning factor α is based on one or more predefined conditions where the corresponding values of the learning factor α is predefined for a condition. The selection of a corresponding value for the learning factor α shall be understood more in detail in the following description of the embodiments of the present invention.

The transaction data store 108 stores various transaction information for the electronic advertisement in respect of the placement of the electronic advertisement on the electronically distributed contents. Examples of transaction information may include a cost per click, a cost per impression, a cost per acquisition, a target cost per click, a return value on investment etc. At least one or more of these values are provided by the advertiser. The transaction information may also include the effective cost per click for the electronic advertisement as determined by the determination module 104, or received through other known means. The transaction information is used by the determination module 104 and the learning module 106 to apply machine learning and statistics to determine successive bid values in accordance with the teachings of the present invention. The bid-values data store 110 stores one or more successive bid values as determined by the determination module 104.

In an implementation, the bidding server 102 can be a computer entity or device that includes respective receiving modules and transmitting modules (not shown in FIG. 1) which are used to receive and send data to various publishers, advertisers, or other ad servers. Further, the communication network 103 refers to any device that allows several users to communicate with the bidding server 102. Examples of the communication network 103 are, but not limited to a local area network, a wide area network, a wireless network, a telecommunication network.

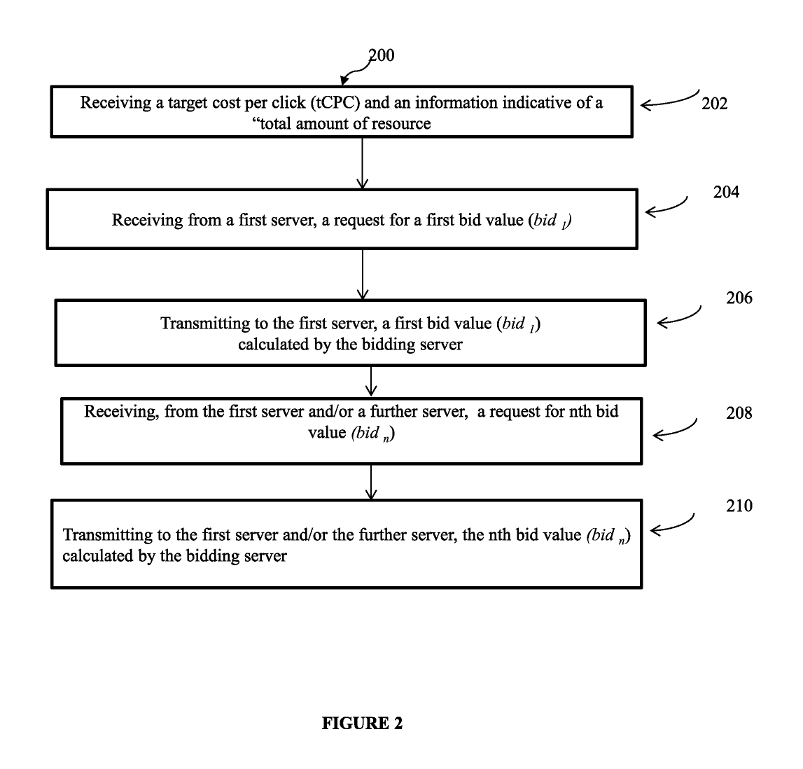

FIG. 2 illustrates a method 200 of successive bidding to be implemented at the bidding server 102 in accordance with an embodiment of the present invention. The method 200 comprises at step 102 of receiving a target cost per click (tCPC) and information indicative of the “total amount of resource” at the bidding server 102. The cost per click can be defined as the price paid by an advertiser for a single click received on its electronic advertisement, wherein the click is defined as a user interaction with the electronic advertisement that leads the user to the advertiser's page. The advertiser page can be the destination website or mobile site or a mobile application that appears as a result of the received click on the advertisement. The target cost per click and the total amount of resource are predefined values provided by the advertiser.

As described before, the successive bid values determined by the bidding server 102 may vary or adjusted based on the adjustment factor. Further, the adjustment factor as determined by the bidding server 102 is based on the learning factor α. The value of the learning factor α can be between 0 and 1. In one implementation, the learning factor α is based at least on the total amount of resource and an available amount of resource. The available amount of resource is determined by the determination module 104 after the end of a respective bidding process. In one example, the available amount of resource is determined as, available amount of resource={the total amount of resource−the amount spent in the previous bidding process}.

Further, the method 200 includes at step 204 receiving from a first server, a request for a first bid or a first bid value for placing of the electronic advertisement on a first electronically distributed content. The first server is a software component or a device which operates on behalf of a first publisher of the first electronically distributed content to which the first bid value is communicated to for the first time by the bidding server 102. The first server sends a request for advertisements for placement the available ad-spaces on its electronically distributed contents. As explained before, multiple advertisers and/or ad networks can participate in the bidding for securing said available ad-spaces for placement of their respective electronic advertisements. The first server therefore requests bid values from one or more bidding servers of advertisers and/or ad networks and accordingly receives bid values in response to its request. To this end, the bidding server 102 receives an invitation to participate in the bidding by means of the request of the first bid.

Further, the method 200 includes at step 206 transmitting, by the bidding server 102 to the first server, a first bid value (bid₁). In one implementation, the bid values are determined based on a CPC model. In another implementation, the bid values are determined based on a CPM model. In yet another implementation, the bid values are determined based on a CPA model. In yet another implementation, the bid values are determined based on a RoAS (Return on Advertising-Spend) model or a ROI (Return on Investment) model, or a cost per sale (CPS) model. In one implementation, the bidding server 102 optimizes bid values in accordance with more than one model. In one such example, the target cost per click (tCPC) provided by an advertiser is based on the CPC model. However, the cost incurred for placing the advertisement on the publisher's electronically distributed content could be based on the CPM model, if the CPM model is preferred by the publisher and/or the ad-network. Still further, the revenue generated by placement of the advertisements could be based only on clicks. The bidding server 102 determines the successive bid values such that the maximum output can be optimized for all the models involved in the bidding process. In this example, the bid value determined could be such that the target cost per click should be achieved as well as the maximum revenue should be generated by placement of the advertisement. By way of another example, in a CPC model, the bidding server 102 optimizes the bid values such that the effective cost per click is at least equal to or less than the target cost per click.

In one implementation, the bidding server 102 determines the bid values based on a CPC model. The first bid value (bid₁) is determined as:

bid₁=adjustment factor₁*tCPC*pCTR₁; (1)

where tCPC is the target cost per click and pCTR₁ is a predicted click-through rate corresponding to the first bid (bid₁). Herein, the value of the adjustment factor₁ corresponds to the first bid, i.e., representing the first time bidding or the first price auction.

In accordance with the embodiments of the present invention, the adjustment factor accounts for any error in the predicted click-through rate so as to achieve the target cost per click. If the predicted click-through rate is accurate, then the effective cost per click achieved is at least equal to the target cost per click. If the predicted click-through rate has any error, then the resultant effective cost per click may be more than the target cost per click. In one implementation, the first bid value is not adjusted, i.e., adjustment factor₁ is kept equal to 1. The first bid is then calculated as {tCPC*pCTR₁}. In another implementation, the successive bid value may also not be adjusted, i.e., the adjustment factor is kept equal to 1, till the next adjustment factor is determined. This implies that the adjustment factors may be determined periodically and accordingly the successive bids may or may not be adjusted depending upon the period in which it is getting determined.

The method 200 at step 206 includes receiving, from the first server and/or a further server, a request for nth bid value. The further server corresponds to software component or a device which operates on behalf of a second publisher of the further electronically distributed contents. The further bid value (bidₙ) herein represents a successive bid value that is adjusted based on the value of the adjustment factor determined corresponding to the nth bidding. The value of n is greater than or equal to 2. This implies that the nth bidding may be the second price auction or the second bidding or further successive bidding wherein the bid value may vary from the first bid, i.e., bid₁. The further bid value (bidₙ) is communicated to the first server and/or the further server by the bidding server 102 on receiving the further bidding request from the respective servers. The further server operates similar to the first server and sends request for advertisements to the bidding server 102 for an available ad space on the second publisher's electronically distributed contents. The bidding server 102 accordingly participates in a second price auction or a successive bidding to transmit a second bid value or nth bid value (bidₙ) to the first server and the further server.

Further, the method 200 at step 208 includes transmitting to the first server and/or the further server, the nth bid value (bidₙ) calculated by the bidding server 102. The nth bid value is calculated as:

bidₙ=adjustment factorₙ*tCPC *pCTRₙ; (2)

where pCTR₍ₙ₋₁₎ is the predicted click-through rate corresponding to the n^{th} bid and the adjustment factorₙ is determined corresponding to the nth bid value (bidₙ). Further, the adjustment factorₙ is determined by the bidding server, as:

adjustment factorₙ=adjustment factor₍ₙ₋₁₎*(1-α((eCPC−tCPC)/eCPC)); (3)

where adjustment factor₍ₙ₋₁₎ corresponds to the adjustment factor determined in a previous bidding process, eCPC is the effective cost per click determined for a previous bidding process, n is greater than or equal to 2 according to the corresponding bidding process, and the learning factor α is a non-zero fraction having a value between 0 and 1. In one implementation, the effective cost per click is determined for a bidding process which involves an adjustment factor determined in the previous bidding process, i.e., adjustment factor₍ₙ₋₁₎. As disclosed above, the adjustment factor adjusts the bid value to account for any error in the predicted click-through rate as determined, so as to achieve the tCPC. By way of an example, the bid value for the first price auction is calculated as: {tCPC*pCTR₁}. In the above case, the effective cost per click may or may not be equal to the target cost per click (tCPC) depending upon the accuracy of the predicted click-through rate. In case of a second price auction, the bid value may need to be increased compared to the first bid value in order to achieve the target cost per click. In such a case, an adjustment factor can be used to increase the bid values. The adjusted bid values, bidₙ can be determined using equation 2{adjustment factorₙ*tCPC*pCTR}.

The bid value as determined are optimized such that the effective cost per click (eCPC) is closer to the target cost per click (tCPC). To this end, the adjustment factor is determined and applied by the bidding server 102 in determining the appropriate bid value with a goal to achieve the eCPC at least equal to or less than the tCPC. In a further implementation of the present invention, the learning factor a is employed in computing the adjustment factor such that the eCPC does not deviate too much, i.e., increase or decrease beyond an acceptable threshold value, from the tCPC. By way of an example, in one of the bidding process, tCPC is set to be 2$. At the end of this bidding process eCPC is found to be 1$. Using equation (3) above, the adjustment factor is determined for the successive bidding process and is found to be double of the first adjustment factor with a learning rate α=1, and the corresponding eCPC at the end of the successive bidding process is found to be 2.5$. Thus, over adjustment in the bid values, determined using the adjustment factor, may also lead to an undesired high eCPC. The learning rate a takes care of the degree of adjustment in the successive bid values determination.

By way of a further example, the value of the learning rate α is selected between 0 and 1 by the learning module 106. As explained before, the learning factor α depends upon the available amount of resource or on how much has already been spent from the total amount of resource provided by the advertiser in adjusting a bid. When there is a large deviation of eCPC from tCPC, the correction is large for the learning rate α (based on adjustment factor equation (3)). This implies that when there is too much deviation of the eCPC from the tCPC, based on an adjusted bid value, then larger correction is required in determining the next adjustment factor so that the eCPC over a longer period averages out. By way of an example, when the resource amount consumed in a bidding process is more than expected on a particular adjustment factor, then for achieving eCPC closer to tCPC over a period of time, one way is to have a higher learning rate α. Thus, the determination module 104 relies on the learning rate α as provided by the learning module 106, to determine the next adjustment factor for the next bidding process. The following examples illustrate some of the use cases of the learning rate α as utilized by the bidding server 102:

Case 1: tCPC=10 Cents;

Initial adjustment factor₁=1; and

Learning factor α=0.5.

Suppose eCPC determined at end of the corresponding bidding is 7 cents.

Then, with a learning factor α=0.5, the adjustment factor, determined using equation (3) is:

$$adjustment {factor}_{2} = 1 * ( 1 - 0.5 ( \frac{7 - 10}{7} ) ) = 1.214 .$$

Thus, the successive bid values shall be adjusted (increased) since eCPC<tCPC.

Suppose the eCPC of the next bidding cycle using adjustment factor₂ is 12 cents. Then adjustment factor₃ will be determined using equation (3) as follows.

$$adjustment {factor}_{3} = 1.214 * ( 1 - 0.5 ( \frac{12 - 10}{12} ) ) = 1.113 .$$

Thus, the adjustment factor herein is reduced compared to adjustment factor₂, since our eCPC>tCPC.
Case 2: tCPC=35 Cents, and Initial Adjustment Factor₁=1.

Suppose eCPC computed at end of the corresponding bidding is 43 cents.

Then, with a learning factor α=0.7, we would have:

$$adjustment {factor}_{2} = 1 * ( 1 - 0.7 ( \frac{43 - 35}{43} ) ) = 0.87 .$$

Thus, the successive bid values shall be adjusted (increased) since eCPC<tCPC .

Suppose the eCPC of the next bidding cycle using the adjustment factor₂ is 36 cents. Then adjustment factor₃ will be determined using equation (3) as follows:

$$adjustment {factor}_{3} = 0.87 * ( 1 - 0.7 ( \frac{36 - 35}{36} ) ) = 0.853 .$$

Here we have again reduced the adjustment factor compared to adjustment factor₂ since our eCPC>tCPC.

By way of another example, the learning factor α is a factor of the available resource amount. Therefore, a higher learning rate α can be used if we spend more than expected in a bidding process relying on a particular adjustment factor. The following examples illustrate some of the use cases when the learning rate α is based on the available resource amount:

### Case 1: A Total Amount Resource is an Allocated Daily Amount Resource: $1200

If the adjustment factor and learning rates are updated hourly, $50 can be spent per hour on the basis of spending uniformly.

Suppose the amount spent in an hour from an available amount of resource, based on one such current adjustment factor, is found to be $80. This value is way higher than the expected amount of resource to be spent per hour, i.e., $50. Thus, the learning rate has to be accordingly increased to accommodate for this huge deviation. Herein, the learning can be set by the learning module 106 using: constant_learning_rate*amount spent_last_hour*24/allocated_daily_resource):

If the constant learning rate is 0.5

New learning rate=0.5*80*24/1200=0.8.

### Case 2: A Total Amount Resource is an Allocated Daily Amount Resource: $1200

If the adjustment factor and learning rates are updated hourly, $50 can be spent per hour on the basis of spending uniformly.

Suppose the amount spent based on one such current adjustment factor is found to be $50. Then the new learning rate is same as the constant learning rate.

By way of another example, the learning factor a can be set by a user 101, for example, the ad network.

In a further implementation of the present invention, in a CPM model, the bidding server 102 optimizes the bid values such that the target cost per impression (tCPM) can be achieved while bidding for an advertisement. The further bid value (bidₙ) is determined by the bidding server 102 using:

bidₙ=adjustment factorₙ*tCPM/1000; (4)

Further, the adjustment factorₙ being determined by the bidding server, as:

adjustment factorₙ=adjustment factor₍ₙ₋₁₎*(1-α((eCPM−tCPM)/eCPM)); (5)

where eCPM is the effective cost per 1000 impressions determined at the end of the corresponding bidding process, tCPM is a target cost per 1000 impressions set by the advertiser, n is greater than or equal to 2, and α is a non-zero fraction having a value between 0 and 1.

In a further implementation, the bidding server 102 optimizes the bid values for a cost per sale model (CPS) or the Return on Advertising Spend (RoAS) model. Herein, the bid values are optimized to drive maximum revenue or to drive a user to make transactions on the advertiser's site. Therefore, the bid values are determined so as to optimize sales driven by an ad-network. The Return on Advertising Spend (RoAS) is defined as:

$$RoAS = \frac{Attributed GMV}{Spend} \qquad ( 6 )$$

The attributed GMV is defined as the gross market value of goods or products driven by an advertisement campaign. Further the term ‘spend’ refers to the amount of resource spent by the ad-network, from the available amount of resource. The value for ‘spend’ can be derived from equation (6) as:

$$Spend = \frac{Attributed GMV ( Gross Market Value )}{RoAS} \qquad ( 7 )$$

The target RoAS is provided by the advertiser. Given a target RoAS, the target spend can be derived using equation (7). Further, for the RoAS model the first bid value (bid₁) is determined by the bidding server 102 using:

bid₁=adjustment factor₁*the target spend/event*an event rate;

where the adjustment factor₁ is equal to 1, the target spend is per event basis, and the event rate is determined using:

event rate=number of user−state transitions/number of impressions (8)

The number of user-state transitions in equation (8) include at least one of these states: opening of an application/website of the advertiser on receiving a click on the advertisement, viewing a product on the advertiser's website or application page, user action of adding the product to a purchase cart on the advertiser's website or application page, user action of checking out on the purchase cart on the advertiser's website or application page and user action resulting in order of the product from the purchase cart on the advertiser's website or application page. The event rate is determined by the determination module 104 of the bidding server 102 at the end of the corresponding bidding process.

Further, for the RoAS model, the further bid value (bidₙ) is determined by the bidding server 102 as:

bidₙ=adjustment factorₙ*the target spend/event*the event rate (9(a))

where the event rate is a value corresponding to the n^{th} bid. In one implementation, the event rate may be based on one or more factors (f₁ . . . fₙ). The one or more factors (f₁ . . . fₙ) can be determined by the determination module 104 in a manner similar to determination of β₁ . . . βₙ, as disclosed in detail below. Further, the adjustment factorₙ being determined by the bidding server 104, as:

adjustment factorₙ−adjustment factor₍ₙ₋₁₎*(1-α((eCPM−tCPM)/eCPM)) (9(b))

In equation 9(b), the term eCPM is defined as the effective cost per 1000 impressions. In one implementation, the eCPM is determined for a bidding process that involves an adjustment factor determined from a previous bidding process, i.e., adjustment factor₍ₙ₋₁₎. The target cost per impression (tCPM) for equation (10) can be derived using:

$$\begin{matrix}tCPM = \frac{Target Spend ( RoAS Model )}{Impressions} & ( 10 ) \\ tCPM = \frac{Attributed GMV}{Target RoAS * Impressions} & ( 11 )\end{matrix}$$

Further, ‘Impressions’ in the equations (10) and (11) corresponds to the number of impressions or the number of times the advertisement is displayed on the corresponding one or more electronically distributed contents.

Further using equations (6) and (7), the first bid value (bid₁) and the further bid value (bidₙ) can also be determined by the bidding server 102 for the cost per sale (CPS) model. Specifically, in equation (6), RoAS is substituted with the cost per sale, as follows:

$$\begin{matrix}CPS = \frac{Spend ( CPS Model )}{Attributed Transactions} & ( 12 ) \\ Spend = Attributed {Transaction }^{*} CPS & ( 13 )\end{matrix}$$

where ‘attributed transactions’ can be defined as the number of orders driven by an advertisement campaign. The ‘order’ herein implies the product orders resulting from user action of placing an order of the product from the purchase cart on the advertiser's website or application page.

In accordance with a further embodiment of the present invention, the method 200 determines the predicted click through rate using equation 1a also disclosed above:

pCTR=β₁ᵢ*β₂ⱼ*β₃ₖ . . . *βₙₘ;

where β₁ᵢ, is one of the possible values of a feature affecting the predicted click-through rate, β₂ⱼ is another possible values of a feature affecting the predicted click-through rate, β₃ₖ is yet another possible values of a feature affecting the predicted click-through rate, and so on.

In one implementation, these features (βₙₘ) include an advertiser related feature (β_{a,i}), an electronically distributed content related feature (β_{s,j}), an electronic advertisement related feature or advertisement creative related feature (β_{c,k}). The advertiser related feature (β_{a,i}) could be a feature related to a specific advertiser=‘i’. For example, ‘i’ could be a proprietor of a mobile gaming application, a proprietor of an e-commerce page, a proprietor of a new product etc. The electronically distributed content related feature (β_{s,j}) could be a feature specific to a publisher's site=‘j’. For example, ‘j’ could be a specific mobile site, mobile application, website etc. pertaining to the publisher of the advertisement. The electronic advertisement related feature or advertisement creative related feature (β_{c,k}) could be a feature related to a specific type of advertisement creative=‘k’. For example, ‘k’ could be a type of ad-format 320*50 or 320*568, etc. In one further implementation, these features (β) also include a slot-size related feature, (β_{slotsize,l}), a country related feature (β_{country,m}) and a time of the day related feature (β_{timeofday,n}). However, the disclosed features should not be construed as limiting to the present invention and many more features as known to affect the predicted click-through rate may be employed by the determination module 104. Further, the determination module 104 also determines values of each of the plurality of independent features to β₁ to βₙ in accordance with the embodiments of the present invention in a manner disclosed in detail below.

In accordance with one implementation, the three features affecting the predicted click through rate including an advertiser related feature (β_{a,i}); an electronically distributed content related feature (β_{s,j}) and an electronic advertisement related feature (β_{c,k}) are calculated as;

$$\begin{matrix}{β}_{a , i} = \frac{{\sum }_{j , k} {w}_{ijk} * {p}_{ijk} * {β}_{s , j} * {β}_{c , k}}{{\sum }_{j , k} {w}_{ijk} * {β}_{s , j}^{2} * {β}_{c , k}^{2}} & ( 14 ) \\ {β}_{s , j} = \frac{{\sum }_{i , k} {w}_{ijk} * {p}_{ijk} * {β}_{a , i} * {β}_{c , k}}{{\sum }_{i , k} {w}_{ijk} * {β}_{a , i}^{2} * {β}_{c , k}^{2}} ; & ( 15 ) \\ c , k = \frac{{\sum }_{i , j} {w}_{ijk} * {p}_{ijk} * {β}_{a , i} * {β}_{s , j}}{{\sum }_{i , j} {w}_{ijk} * {β}_{a , i}^{2} * {β}_{s , , j}^{2}} & ( 16 )\end{matrix}$$

where w_{i,jk} represents the number of impressions for an advertiser=‘i’, an electronically distributed content=‘j’, and an electronic advertisement=‘k’, and pᵢⱼₖ is the previously determined click through rate for a combination of the advertiser ‘i’, the electronically distributed content ‘j’, and the electronic advertisement ‘k’.

By way of an example, the following table illustrates an example of different advertisers (‘Advertisers’), different electronically distributed contents (‘Sites’) and different electronic advertisements (‘Advertisement content’ in different formats) and the corresponding predicted click-through rate (‘CTR’) found for the combined factors (i.e., β_{a,i}*β_{s,j}*β_{c,k}):

| Advertiser β_{a,i} | Site β_{s,j} | Advertisement content β_{c,k} | CTR |
|---|---|---|---|
| a1 | s1 | 320 * 50 | 0.5 |
| a1 | s2 | 320 * 568 | 0.8 |
| a2 | s1 | 320 * 50 | 0.2 |

In accordance with another implementation, the six features affecting the predicted click through rate including an advertiser related feature (β_{a,i}); an electronically distributed content related feature (β_{s,j}) and an electronic advertisement related feature (β_{c,k}), a slot size related feature (β_{slotsize,l}), a country related feature (β_{country,m}) and a time of the day related feature (β_{timeofday,n}), are calculated by the bidding server 102 as follows:

$$\begin{matrix}{β}_{a , i} = \frac{\begin{matrix}{\sum }_{j , k , l , m . n} {w}_{ijklmn} * {p}_{ijklmn} * {β}_{s , j} * {β}_{c , k} * \\ ( {β}_{slotsize , l} ) * ( {β}_{country , m} ) * ( {β}_{timeofday , n} )\end{matrix}}{\begin{matrix}{\sum }_{j , k , l , m . n} {w}_{ijklmn} * {β}_{s , j}^{2} * {β}_{c , k}^{2} * {( {β}_{slotsize , l} )}^{2} * \\ {( {β}_{country , m} )}^{2} * {( {β}_{timeofday , n} )}^{2}\end{matrix}} ; & ( 17 ) \\ {β}_{s , j} = \frac{\begin{matrix}{\sum }_{i , k , l , m , n} {w}_{ijklmn} * {p}_{ijklmn} * {β}_{a , i} * {β}_{c , k} * \\ ( {β}_{slotsize , l} ) * ( {β}_{country , m} ) * ( {β}_{timeofday , n} )\end{matrix}}{\begin{matrix}{\sum }_{i , k , l , m , n} {w}_{ijklmn} * {β}_{a , i}^{2} * {β}_{c , k}^{2} * {( {β}_{slotsize , l} )}^{2} * \\ {( {β}_{country , m} )}^{2} * {( {β}_{timeofday , n} )}^{2}\end{matrix}} ; & ( 18 ) \\ {β}_{c , k} = \frac{\begin{matrix}{\sum }_{i , j , l , m , n} {w}_{ijklmn} * {p}_{ijklmn} * {β}_{a , i} * {β}_{s , j} * \\ ( {β}_{slotsize , l} ) * ( {β}_{country , m} ) * ( {β}_{timeofday , n} )\end{matrix}}{\begin{matrix}{\sum }_{i , j , l , m , n} {w}_{ijklmn} * {β}_{a , i}^{2} * {β}_{s , j}^{2} * {( {β}_{slotsize , l} )}^{2} * \\ {( {β}_{country , m} )}^{2} * {( {β}_{timeofday , n} )}^{2}\end{matrix}} ; & ( 19 ) \\ {β}_{slotsize , l} = \frac{\begin{matrix}{\sum }_{i , j , k , m , n} {w}_{ijklmn} * {p}_{ijklmn} * {β}_{a , i} * {β}_{s , j} * {β}_{c , k} * \\ ( {β}_{country , m} ) * ( {β}_{timeofday , n} )\end{matrix}}{\begin{matrix}{\sum }_{i , j , k , m , n} {w}_{ijklmn} * {β}_{a , i}^{2} * {β}_{s , j}^{2} * {β}_{c , k}^{2} * \\ {( {β}_{country , m} )}^{2} * {( {β}_{timeofday , n} )}^{2}\end{matrix}} & ( 20 ) \\ {β}_{country , m} = \frac{\begin{matrix}{\sum }_{i , j , k , l , n} {w}_{ijklmn} * {p}_{ijklmn} * {β}_{a , i} * {β}_{s , j} * {β}_{c , k} * \\ ( {β}_{slotsize , l} ) * ( {β}_{timeofday , n} )\end{matrix}}{\begin{matrix}{\sum }_{i , j , k , l , n} {w}_{ijklmn} * {β}_{a , i}^{2} * {β}_{s , j}^{2} * {β}_{c , k}^{2} * \\ {( {β}_{slotsize , l} )}^{2} * {( {β}_{timeofday , n} )}^{2}\end{matrix}} & ( 21 ) \\ {β}_{timeofday , n} = \frac{\begin{matrix}{\sum }_{i , j , k , l , m} {w}_{ijklmn} * {p}_{ijklmn} * {β}_{a , i} * {β}_{s , j} * {β}_{c , k} * \\ ( {β}_{slotsize , l} ) * ( {β}_{country , m} )\end{matrix}}{\begin{matrix}{\sum }_{i , j , k , l , m} {w}_{ijklmn} * {{β}_{a , i}^{2}}^{*} * {β}_{s , j}^{2} * {β}_{c , k}^{2} * \\ {( {β}_{slotsize , l} )}^{2} * {( {β}_{timeofday , n} )}^{2}\end{matrix}} & ( 22 )\end{matrix}$$

where wᵢⱼₖₗₘₙ represents the number of impressions for an advertiser=‘i’, an electronically distributed content=‘j’, an electronic advertisement=‘k’, a slot size=‘l’, a country=‘m’, and a time of the day=‘timeofday’, and pᵢⱼₖₗₘₙ is the previously determined value of the click through rate for a combination of the advertiser ‘i’, the electronically distributed content ‘j’, the electronic advertisement ‘k’, a slot size ‘l’, a country ‘m’, and a time of the day ‘timeofday’.

By way of an example, the equations (14) to (16), and equations (17) to (22) are solved by initializing all the factors to one, and solve these equations iteratively till they converge

Similar to the manner of calculation of the factors (βₙₘ) obtained from corresponding equations (14), (15) and (16) and the corresponding equations (17), (18), (19), (20), (21), and (22), any number of factors affecting the predicting click-through rate can be calculated, keeping the other factors constant and obtaining the corresponding number of impressions and the previously determined click through-rate for the combination of the corresponding factors. In an implementation, such other factors are initialized to the value 1 till these factors are also computed.

In accordance with another implementation of the present invention, the method 200 comprises of normalizing the electronically distributed content related feature, also referred to as the site related feature,(β_{s,j}) and the electronic advertisement related feature, also referred to as the creative related feature (β_{c,k}), for a new and/or an unknown site.

By way of an example, the normalization of the factors can be done after all the factors (β₁ᵢ . . . βₙₘ) have been determined. Once, all the factors are determined, normalization can be done and all the bias can be moved to the advertiser related feature (β_{a,i}) by having the weighted product of the electronically distributed content related feature, also referred to as the ‘site related feature’ hereafter, (β_{s,j}) and the advertisement related feature(β_{c,k}), as 1. After normalization, any unknown feature, or the associated factor, except the advertiser related feature (β_{a,i}) can have a default value of 1.

In one such example, the normalization of the factors is done as follows:

A generic equation for calculating the predicted click-through rate (CTR) can be expressed as:

pᵢⱼₖ=β_{a,i}*β_{s,j}*β_{c,k} (23)

All the bias can be moved to the advertiser related feature (β_{a,i}). First, we take log on both sides in equation (23)

log (pᵢⱼₖ)−log(β_{a,i})+log(β_{s,j})+log(β_{c,k}) (24)

From equation (24), we can derive a form:

Cᵢⱼₖ=xᵢ+yⱼ+zₖ (25)

Now we make the following transformations:

y′ⱼ=yⱼ−ywhere y is the weighted mean of all yⱼ (weighted on number of impressions) (26)

z′ₖ=zₖ z where z is the weighted mean of all zₖ (weighted on number of impressions) (27)

x′ᵢ=xᵢ+y+z (28)

The above transformations do not change the individual equations, but they have the added advantage that Σⱼ wⱼ y′ⱼ=0, wherein wⱼ is the number of impressions of site=‘j’. The equation (26) implies that sum of log CTR factors for the site related feature (β_{s,j}) is 0. This also implies that the product of the CTR factors for the site related feature (β_{s,j}) is 1. For example, if there are three site related features s1, s2 and s3, the CTR factors for the site related features could be β_{s,1}, β_{s,2}, β_{s,3} etc. The sum of log CTR factors for the site related feature could be therefore represented as: log(β_{s,1})+log(β_{s,2})+log(β_{s,3}). And product of the CTR factors for the site related feature could be represented as: (β_{s,1})*(β_{s,2})*(β_{s,3}). Similarly, we get Σₖ wₖzₖ=0, where wₖ is the number of impressions of creative=‘k’. Thus, all the bias has been shifted to which is the log CTR factor for the advertiser related feature. All the other factors, i.e., except the advertiser related features have been normalized. This means that unknown feature values can be assigned a factor value of 1.

In accordance with a further embodiment of the present invention, the bias can be moved to yet another feature for a new or an unknown advertiser related feature, without going beyond the scope of the present invention. By way of an example, a factor affecting the predicted click-through rate can be corresponding to a country related feature and all the bias can be moved to this factor, while other factors can be normalized.

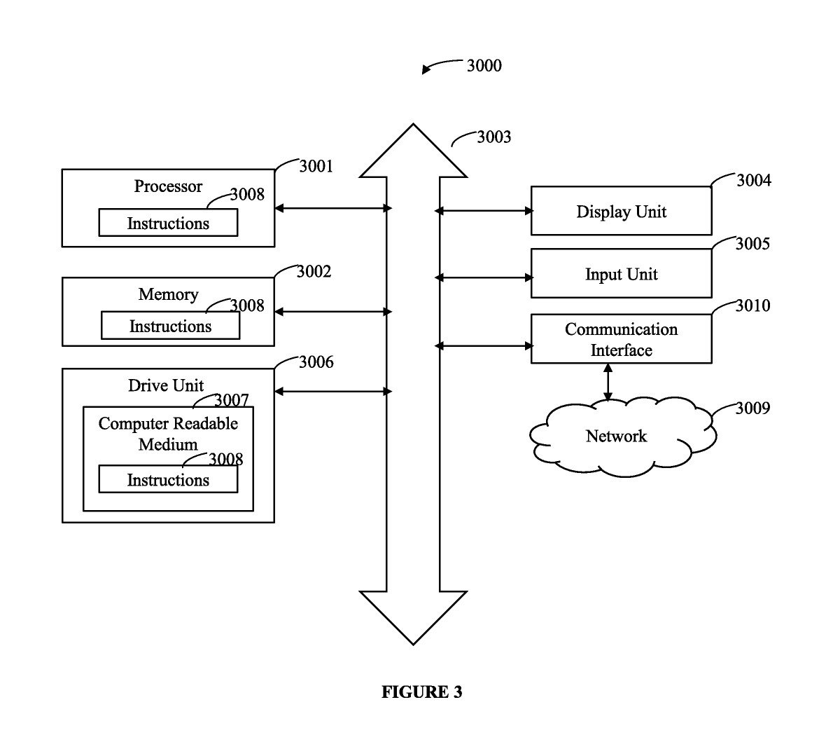

FIG. 3 illustrates a typical hardware configuration of the bidding server 102 implemented in the form of a computer system 3000 implementing the method 200 of the present invention. The computer system 3000 can include a set of instructions that can be executed to cause the computer system 3000 to perform any one or more of the methods disclosed. The computer system 3000 may operate as a standalone device or may be connected, e.g., using a network, to other computer systems or peripheral devices such as the first server and the further servers.

In a networked deployment, the computer system 3000 may operate in the capacity of a server or as a client user computer in a server-client user network environment, or as a peer computer system in a peer-to-peer (or distributed) network environment. The computer system 3000 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone having a touch-screen user interface, or any other machine capable of executing a set of instructions (sequential or otherwise) that specify actions to be taken by that machine. Further, while a single computer system 3000 is illustrated, the term “system” shall also be taken to include any collection of systems or sub-systems that individually or jointly execute a set, or multiple-sets, of instructions to perform one or more computer functions.

The computer system 3000 may include a processor 3001 e.g., a central processing unit (CPU), a graphics processing unit (GPU), or both. The processor 3001 may be a component in a variety of systems. For example, the processor 3001 may be part of a standard personal computer or a workstation. The processor 3001 may be one or more general processors, digital signal processors, application specific integrated circuits, field programmable gate arrays, servers, networks, digital circuits, analog circuits, combinations thereof, or other now known or later developed devices for analyzing and processing data The processor 3001 may implement a software program, such as code generated manually (i.e., programmed).

The computer system 3000 may include a memory 3002 that can communicate via a bus 3003. The memory 3002 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 3002 includes a cache or random access memory for the processor 3001. In alternative examples, the memory 3002 is separate from the processor 3001, such as a cache memory of a processor, the system memory, or other memory. The memory 3002 may be an external storage device or database for storing data. The memory 3002 is operable to store instructions 3008 executable by the processor 3001. The functions, acts or tasks illustrated in the figures or described may be performed by the programmed processor 3001 executing the instructions stored in the memory 3002. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 3000 may further include a display unit 3004, such as a liquid crystal display (LCD), an organic light emitting diode (OLED), a flat panel display, a solid state display, a cathode ray tube (CRT), a projector, a printer or other now known or later developed display device for outputting determined information. The display unit 3004 may act as an interface for the user to see the functioning of the processor 3001, or specifically as an interface with the software stored in the memory 3002 or in a drive unit 3006. The computer system 3000 may also include a disk or optical drive unit 3006. The disk drive unit 3006 may include a computer-readable medium 3007 in which one or more sets of instructions 3008, e.g. software, can be embedded. Further, the instructions 3008 may embody one or more of the methods or logic as described. In a particular example, the instructions 3008 may reside completely, or at least partially, within the memory 3002 or within the processor 3001 during execution by the computer system 3000. The processor 3001 and the memory 3002 may also include computer-readable media 3007 as discussed above.

Additionally, the computer system 3000 may include an input unit 3005 configured to allow a user to interact with any of the components of computer system 3000. The input unit 3005 may be a number pad, a keyboard, or a cursor control device, such as a mouse, or a joystick, touch screen display, remote control or any other device operative to interact with the computer system 3000.

The present invention contemplates a computer-readable medium 3007 that includes instructions 3008 or receives and executes instructions 3008 responsive to a propagated signal so that a device connected to a network 3009 can communicate voice, video, audio, images or any other data over the network 3009. Further, the instructions 3008 may be transmitted or received over the network 3009 via a communication port or interface 3010 or using the bus 3003. The communication port or interface 3010 may be a part of the processor 3001 or may be a separate component. The communication port 3010 may be created in software or may be a physical connection in hardware. The communication port 3010 may be configured to connect with the network 3009, external media, the display 3004, or any other components in computer system 3000, or combinations thereof. The connection with the network 3009 may be a physical connection, such as a wired Ethernet connection or may be established wirelessly as discussed later. Likewise, the additional connections with other components of the computer system 3000 may be physical connections or may be established wirelessly. The network 3009 may alternatively be directly connected to the bus 3003.

The network 3009 may include wireless networks, Ethernet AVB networks, or combinations thereof. The wireless network may be a cellular telephone network, an 802.11, 802.16, 802.20, 802.1Q or WiMax network. Further, the network 3009 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet switched network transmission (e.g., TCP/IP, UDP/IP, HTML, HTTP) may be used.

Overall, the present subject matter enables providing bid values for an electronic advertisement placement on publisher's mobile sites or apps. The bid values are optimized considering machine learning factors and applied statistics that are able to match maximum return on investment for publishers and at the same time achieve the target cost per click of advertisers. Additionally, using the machine learning factors and applied statistics, the predicted click through rate is also accurately determined for new electronic advertisements or least clicks generating advertisements. While specific language has been used to describe the disclosure, any limitations arising on account of the same are not intended. As would be apparent to a person in the art, various working modifications may be made to the method in order to implement the inventive concept as taught herein. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A computer-implemented method of successive bidding, the bidding being in relation to placement of an electronic advertisement on one or more electronically distributed content, the method comprising:
receiving, at a bidding server, a target cost per click (tCPC) and an information indicative of a “total amount of resource”;
receiving, by the bidding server from a first server, a request for a first bid for placing of the electronic advertisement on a first electronically distributed content;
transmitting, by the bidding server to the first server, a first bid value (bid₁) calculated by the bidding server, as:
bid₁=adjustment factor₁*tCPC*pCTR₁;
where:
adjustment factor₁ is equal to 1; and
pCTR₁ is a predicted click through rate corresponding to the first bid;
receiving, by the bidding server from the first server and/or a further server, a request for n^{th} bid for placing of the electronic advertisement on the first electronically distributed content and/or a further electronically distributed content; and
transmitting, by the bidding server to the first server and/or the further server, a n^{th} bid value (bidₙ) calculated by the bidding server, as:
bidₙ=adjustment factorₙ*tCPC*pCTRₙ;
where:
pCTRₙ is predicted click through rate corresponding to the n^{th} bid;
adjustment factorₙ being determined by the bidding server, as:
$$adjustment {factor}_{n} = adjustment {factor}_{( n - 1 )} * ( 1 - α ( \frac{eCPC - tCPC}{eCPC} ) ) ;$$
where:
eCPC is an effective cost per click;
n is greater than or equal to 2; and
α is a non-zero fraction having a value between 0 and 1.

2. A computer-implemented method as claimed in claim 1, wherein the value of α is dependent upon at least one of the “total amount of resource” and an “available amount of resource”.

3. A computer-implemented method as claimed in claim 2 further comprising determining the “available amount of resource”.

4. A computer-implemented method as claimed in claim 1 further comprising determining a value of the effective cost per click (eCPC).

5. A computer-implemented method as claimed in claim 1, wherein the adjustment factorₙ being determined by the bidding server, periodically.

6. A computer-implemented method as claimed in claim 1 further comprising calculating the predicted click through rate (pCTR), as:
pCTR=β₁ᵢ*β₂ⱼ*β₃ₖ. . . *βₙₘ;
where β₁ᵢ-βₙₘ are independent features affecting the predicted click through rate.

7. A computer-implemented method as claimed in claim 5, wherein the features affecting the predicted click through rate include an advertiser related feature (β_{a,i}); an electronically distributed content related feature (β_{s,j}) and an electronic advertisement related feature (β_{c,k});
where β_{a,i} is calculated by the bidding server, as:
$${β}_{a , i} = \frac{{\sum }_{j , k} {w}_{ijk} * {p}_{ijk} * {β}_{s , j} * {β}_{c , k}}{{\sum }_{j , k} {w}_{ijk} * {β}_{s , j}^{2} * {β}_{c , k}^{2}} ;$$
where β_{s,j} is calculated by the bidding server, as:
$${β}_{s , j} = \frac{{\sum }_{i , k} {w}_{ijk} * {p}_{ijk} * {β}_{a , i} * {β}_{c , k}}{{\sum }_{i , k} {w}_{ijk} * {β}_{a , i}^{2} * {β}_{c , k}^{2}} ;$$
where β_{c,k} is calculated by the bidding server, as:
$${β}_{c , k} = \frac{{\sum }_{i , j} {w}_{ijk} * {p}_{ijk} * {β}_{a , i} * {β}_{s , j}}{{\sum }_{i , j} {w}_{ijk} * {β}_{a , i}^{2} * {β}_{s , , j}^{2}} ;$$
and
where wᵢⱼₖ represents the number of impressions for an advertiser=‘i’, an electronically distributed content=‘j’, and an electronic advertisement=‘k’, and pᵢⱼₖ is a previously determined value of the click through rate for a combination of the advertiser ‘i’, the electronically distributed content ‘j’, and the electronic advertisement ‘k’.

8. A computer-implemented method as claimed in claim 6, comprising normalizing the electronically distributed content related feature (β_{s,j}) and the electronic advertisement related feature (β_{c,k}) for a new and/or an unknown site such that the new and/or unknown site has a β value of 1.

9. A computer-implemented method as claimed in claim 6, wherein the features affecting the predicted click through rate further include a slot size related feature (β_{slotsize,l}), a country related feature (β_{country,m}) and a time of the day related feature (β_{timeofday,n});
where β_{a,i} is calculated by the bidding server, as:
$${β}_{a , i} = \frac{\begin{matrix}{\sum }_{j , k , l , m . n} {w}_{ijklmn} * {p}_{ijklmn} * {β}_{s , j} * \\ {β}_{c , k} * ( {β}_{slotsize , l} ) * ( {β}_{country , m} ) * ( {β}_{timeofday , n} )\end{matrix}}{\begin{matrix}{\sum }_{j , k , l . m . n} {w}_{ijklmn} * {β}_{s , j}^{2} * {β}_{c , k}^{2} * \\ {( {β}_{slotsize , l} )}^{2} * {( {β}_{country , m} )}^{2} * {( {β}_{timeofday , n} )}^{2}\end{matrix}} ;$$
where β_{s,j} is calculated by the bidding server, as:
$${β}_{s , j} = \frac{\begin{matrix}{\sum }_{i , k , l , m , n} {w}_{ijklmn} * {p}_{ijklmn} * {β}_{a , i} * \\ {β}_{c , k} * ( {β}_{slotsize , l} ) * ( {β}_{country , m} ) * ( {β}_{timeofday , n} )\end{matrix}}{\begin{matrix}{\sum }_{i , k , l , m , n} {w}_{ijklmn} * {β}_{a , i}^{2} * {β}_{c , k}^{2} * \\ {( {β}_{slotsize , l} )}^{2} * {( {β}_{country , m} )}^{2} * {( {β}_{timeofday , n} )}^{2}\end{matrix}} ;$$
where β_{c,k} is calculated by the bidding server, as:
$${β}_{c , k} = \frac{\begin{matrix}{\sum }_{i , j , l , m , n} {w}_{ijklmn} * {p}_{ijklmn} * {β}_{a , i} * \\ {β}_{s , j} * ( {β}_{slotsize , l} ) * ( {β}_{country , m} ) * ( {β}_{timeofday , n} )\end{matrix}}{\begin{matrix}{\sum }_{i , j , l , m , n} {w}_{ijklmn} * {β}_{a , i}^{2} * {β}_{s , j}^{2} * \\ {( {β}_{slotsize , l} )}^{2} * {( {β}_{country , m} )}^{2} * {( {β}_{timeofday , n} )}^{2}\end{matrix}} ;$$
where β_{slotsize,l} is calculated by the bidding server, as:
$${β}_{slotsize , l} = \frac{\begin{matrix}{\sum }_{i , j , k , m , n} {w}_{ijklmn} * {p}_{ijklmn} * {β}_{a , i} * {β}_{s , j} * \\ {β}_{c , k} * ( {β}_{country , m} ) * ( {β}_{timeofday , n} )\end{matrix}}{\begin{matrix}{\sum }_{i , j , k , m , n} {w}_{ijklmn} * {β}_{a , i}^{2} * {β}_{s , j}^{2} * {β}_{c , k}^{2} * \\ {( {β}_{country , m} )}^{2} * {( {β}_{timeofday , n} )}^{2}\end{matrix}} ;$$
where β_{country,m} is calculated by the bidding server, as:
$${β}_{country , m} = \frac{\begin{matrix}{\sum }_{i , j , k , l , n} {w}_{ijklmn} * {p}_{ijklmn} * {β}_{a , i} * {β}_{s , j} * \\ {β}_{c , k} * ( {β}_{slotsize , l} ) * ( ( {β}_{timeofday , n} )\end{matrix}}{\begin{matrix}{\sum }_{i , j , k , l , n} {w}_{ijklmn} * {β}_{a , i}^{2} * {β}_{s , j}^{2} * {β}_{c , k}^{2} * \\ {( {β}_{slotsize , l} )}^{2} * {( {β}_{timeofday , n} )}^{2}\end{matrix}} ;$$
where β_{timeofday,n} is calculated by the bidding server, as:
$${β}_{timeofday , n} = \frac{\begin{matrix}{\sum }_{i , j , k , l , m} {w}_{ijklmn} * {p}_{ijklmn} * {β}_{a , i} * {β}_{s , j} * \\ {β}_{c , k} * ( {β}_{slotsize , l} ) * ( {β}_{country , m} )\end{matrix}}{\begin{matrix}{\sum }_{i , j , k , l , m} {w}_{ijklmn} * {β}_{a , i}^{2} * {β}_{s , j}^{2} * {β}_{c , k}^{2} * \\ {( {β}_{slotsize , l} )}^{2} * {( {β}_{timeofday , n} )}^{2}\end{matrix}} ;$$
where wᵢⱼₖₗₘₙ represents the number of impressions for an advertiser=‘i’, an electronically distributed content=‘j’, an electronic advertisement=‘k’, a slot size=‘l’, a country=‘m’, and a time of the day=‘timeofday’, and pᵢⱼₖₗₘₙ is the previously determined value of the click through rate for a combination of the advertiser ‘i’, the electronically distributed content ‘j’, the electronic advertisement ‘k’, a slot size ‘l’, a country ‘m’, and a time of the day ‘timeofday’.

10. A computer-implemented method of bidding, the bidding being in relation to placement of an electronic advertisement on an electronically distributed content, the method comprising:
receiving, at a bidding server, a target cost per click (tCPC) and an information indicative of a “total amount of resource”;
receiving, by the bidding server from a server, a request for a first bid for placing of the electronic advertisement on the electronically distributed content;
transmitting, by the bidding server to the first server, a first bid value (bid₁) calculated by the bidding server, as:
bid₁=adjustment factor₁*tCPC*pCTR₁;
where:
adjustment factor₁ is equal to 1; and
pCTR₁ is a predicted click through rate corresponding to the first bid and is calculated as:
pCTR=β_{a,i}*β_{s,j}*β_{c,k};
where β_{a,i} represents an advertiser related feature affecting the predicted click through rate; β_{s,j} represents an electronically distributed content related feature affecting the predicted click through rate; and β_{c,k} represents an electronic advertisement related feature affecting the predicted click through rate;
where β_{a,i}, is calculated by the bidding server, as:
$${β}_{a , i} = \frac{{\sum }_{j , k} {w}_{ijk} * {p}_{ijk} * {β}_{s , j} * {β}_{c , k}}{{\sum }_{j , k} {w}_{ijk} * {β}_{s , j}^{2} * {β}_{c , k}^{2}} ;$$
where β_{a,j} is calculated by the bidding server, as:
$${β}_{s , j} = \frac{{\sum }_{i , k} {w}_{ijk} * {p}_{ijk} * {β}_{a , i} * {β}_{c , k}}{{\sum }_{i , k} {w}_{ijk} * {β}_{a , i}^{2} * {β}_{c , k}^{2}} ;$$
where β_{c,k} is calculated by the bidding server, as:
$${β}_{c , k} = \frac{{\sum }_{i , j} {w}_{ijk} * {p}_{ijk} * {β}_{a , i} * {β}_{s , j}}{{\sum }_{i , j} {w}_{ijk} * {β}_{a , i}^{2} * {β}_{s , j}^{2}} ;$$
and
where wᵢⱼₖ represents a number of impressions for an advertiser=‘i’, an electronically distributed content=‘j’, and an electronic advertisement=‘k’, and pᵢⱼₖ is the previously determined value of the click through rate for a combination of the advertiser ‘i’, the electronically distributed content ‘j’, and the electronic advertisement ‘k’.

11. A bidding server for successive bidding, the bidding being in relation to a placement of an electronic advertisement on one or more electronically distributed content, the bidding server comprising:
a first receiving unit to receive a target cost per click (tCPC) and an information indicative of a “total amount of resource”;
a second receiving unit to receive from a first server, a request for a first bid for placing of the electronic advertisement on a first electronically distributed content, and to further revive from the first server and/or a further server, a request for n^{th} bid for placing of the electronic advertisement on the first electronically distributed content and/or a further electronically distributed content;
a processor to calculate a first bid value (bid₁) and to calculate a nth bid value bid value (bidₙ);
wherein the first bid (bid₁) value is calculated as:
bid₁=adjustment factor₁* tCPC*pCTR₁;
where:
adjustment factor₁ is equal to 1; and
pCTR₁ is a predicted click through rate corresponding to the first bid; and
wherein the nth bid (bidₙ) value is calculated as:
bidₙ=adjustment factorₙ* tCPC*pCTRₙ;
where:
pCTRₙ is predicted click through rate corresponding to the n^{th} bid;
adjustment factorₙ being determined by the bidding server, as:
$$adjustment {factor}_{n} = adjustment {factor}_{( n - 1 )} * ( 1 - α ( \frac{eCPC - tCPC}{eCPC} ) ) ;$$
where:
eCPC is an effective cost per click;
n is greater than or equal to 2; and
α is a non-zero fraction having a value between 0 and 1.
a transmitter to transmit the first bid value to the first server and the nth bid value to the first server and/or the further server.

12. A bidding server for successive bidding, the bidding being in relation to a placement of an electronic advertisement on one or more electronically distributed content, the bidding server comprising:
a first receiving unit to receive a target cost per click (tCPC) and an information indicative of a “total amount of resource”;
a second receiving unit to receive from a first server, a request for a first bid for placing of the electronic advertisement on a first electronically distributed content,
a processor to calculate a first bid value (bid₁) as:
bid₁=adjustment factor₁*tCPC*pCTR₁;
where:
adjustment factor₁ is equal to 1; and
pCTR₁ is a predicted click through rate corresponding to the first bid and is calculated as:
pCTR−β_{a,i}*β_{s,j}*β_{c,k};
where β_{a,i} represents an advertiser related feature affecting the predicted click through rate; ,β_{s,j} represents an electronically distributed content related feature affecting the predicted click through rate; and β_{c,k} represents an electronic advertisement related feature affecting the predicted click through rate;
where β_{a,i} is calculated by the bidding server, as:
$${β}_{a , i} = \frac{{\sum }_{j , k} {w}_{ijk} * {p}_{ijk} * {β}_{s , j} * {β}_{c , k}}{{\sum }_{j , k} {w}_{ijk} * {β}_{s , j}^{2} * {β}_{c , k}^{2}} ;$$
where β_{s,j} is calculated by the bidding server, as:
$${β}_{s , j} = \frac{{\sum }_{i , k} {w}_{ijk} * {p}_{ijk} * {β}_{a , i} * {β}_{c , k}}{{\sum }_{i , k} {w}_{ijk} * {β}_{a , i}^{2} * {β}_{c , k}^{2}} ;$$
where β_{c,k} is calculated by the bidding server, as:
$${β}_{c , k} = \frac{{\sum }_{i , j} {w}_{ijk} * {p}_{ijk} * {β}_{a , i} * {β}_{s , j}}{{\sum }_{i , j} {w}_{ijk} * {β}_{a , i}^{2} * {β}_{s , j}^{2}} ;$$
where wᵢⱼₖ represents the number of impressions for an advertiser=‘i’, an electronically distributed content=‘j’, and an electronic advertisement=‘k’; and a transmitter to transmit the first bid value to the first server, and pᵢⱼₖ is the previously determined value of the click through rate for a combination of the advertiser ‘k’, the electronically distributed content ‘j’, and the electronic advertisement ‘k’; and
a transmitter to transmit the first bid value to the first server.
